(19) United States
(12) Patent Application Publication
(10) Pub. No.: US 2015/0030019 A1
(43) Pub. Date: Jan. 29, 2015

(54) MOBILE SWITCHING CENTER ACTING AS A SHORT MESSAGE SERVICE GATEWAY

(71) Applicants: Devaki Chandramouli, Plano, TX (US); Rainer Liebhart, Munich (DE); Curt Wong, Bellevue, WA (US)

(72) Inventors: Devaki Chandramouli, Plano, TX (US); Rainer Liebhart, Munich (DE); Curt Wong, Bellevue, WA (US)

(73) Assignee: NOKIA SOLUTIONS AND NETWORKS OY, Espoo (FI)

(21) Appl. No.: 14/387,907

(22) PCT Filed: Mar. 26, 2012
(86) PCT No.: PCT/US12/30542

§ 371 Date: Sep. 25, 2014

(51) Int. Cl. H04W 4/14; H04L 12/66

(52) U.S. Cl. CPC H04W 4/14; H04L 12/66; H04W 88/184
USPC 370/356

(57) ABSTRACT

Communications systems, such as the evolved packet system, may benefit from configurations and methods for a mobile switching center. For example, a mobile switching center may be configured to act as a short message service gateway. A method can include communicating, by a mobility management entity, regarding a user equipment with a home subscriber server of the user equipment. The method can also include determining whether a mobility management entity communicates with a short message service gateway mobile switching center regarding the user equipment based on communication with the home subscriber server.

### BACKGROUND

1. Field

Communications systems, such as the evolved packet system, may benefit from configurations and methods for a mobile switching center. For example, a mobile switching center may be configured to act as a short message service gateway.

2. Description of the Related Art

The evolved packet system (EPS), the successor of general packet radio system (GPRS), provides radio interfaces and packet core network functions for broadband wireless data access. EPS core network functions include the mobility management entity (MME), the packet data network gateway (PDN-GW) and the Serving Gateway (S-GW). An example of an evolved packet core architecture is illustrated in FIG. 1 and is described by third generation partnership project (3GPP) technical specification (TS) 23.401, which is incorporated herein by reference in its entirety. A common packet domain core network can be used for both radio access networks (RANs), the global system for mobile communication (GSM) enhanced data rates for GSM evolution (EDGE) radio access network (GERAN) and the universal terrestrial radio access network (UTRAN).

Currently, second and third generation circuit switched (CS) infrastructure or support for an internet protocol (IP) multimedia subsystem (IMS) may be required to support voice and especially short message service (SMS) services in packet switched (PS), for example, circuit switched fallback (CSFB), single radio voice call continuity (SRVCC), and IMS based voice over IP (VoIP). One approach to provide such support is to provide SMS services in an MME. This approach, however, introduces circuit switched functionality into a packet core entity and requires devices to perform a combined attach in order to obtain SMS services.

### SUMMARY

According to certain embodiments, a method includes operating a mobile switching center in a core network. The method also includes configuring the mobile switching center to act as a short message service gateway.

In certain embodiments, a method includes communicating, by a mobility management entity, regarding a user equipment with a home subscriber server of the user equipment. The method also includes determining whether to communicate with a short message service gateway mobile switching center regarding the user equipment based on communication with the home subscriber server.

An apparatus, according to certain embodiments includes at least one memory including computer program code and at least one processor. The at least one memory and the computer program code are configured to, with the at least one processor, cause the apparatus at least to operate a mobile switching center in a core network. The at least one memory and the computer program code are also configured to, with the at least one processor, cause the apparatus at least to configure the mobile switching center to act as a short message service gateway.

An apparatus, in certain embodiments, includes at least one memory including computer program code and at least one processor. The at least one memory and the computer program code are configured to, with the at least one processor, cause the apparatus at least to communicate, by a mobility management entity, regarding a user equipment with a home subscriber server of the user equipment. The at least one memory and the computer program code are configured to, with the at least one processor, cause the apparatus at least to determine whether to communicate with a short message service gateway mobile switching center regarding the user equipment based on communication with the home subscriber server.

A non-transitory computer-readable medium is, according to certain embodiments, encoded with instructions that, when executed in hardware, perform a process. The process includes operating a mobile switching center in a core network. The process also includes configuring the mobile switching center to act as a short message service gateway.

A non-transitory computer-readable medium is, in certain embodiments, encoded with instructions that, when executed in hardware, perform a process. The process includes communicating, by a mobility management entity, regarding a user equipment with a home subscriber server of the user equipment. The process also includes the mobility management entity determining whether to communicate with a short message service gateway mobile switching center regarding the user equipment based on communication with a home subscriber server.

An apparatus, according to certain embodiments, includes operation means for operating a mobile switching center in a core network. The apparatus also includes configuration means for configuring the mobile switching center to act as a short message service gateway.

In certain embodiments, an apparatus includes communication means for communicating, by a mobility management entity, regarding a user equipment with a home subscriber server of the user equipment. The apparatus also includes determination means for determining whether to communicate with a short message service gateway mobile switching center regarding the user equipment based on communication with a home subscriber server.

### BRIEF DESCRIPTION OF THE DRAWINGS

For proper understanding of the invention, reference should be made to the accompanying drawings, wherein:

FIG. 1 illustrates a network including an evolved packet core architecture.

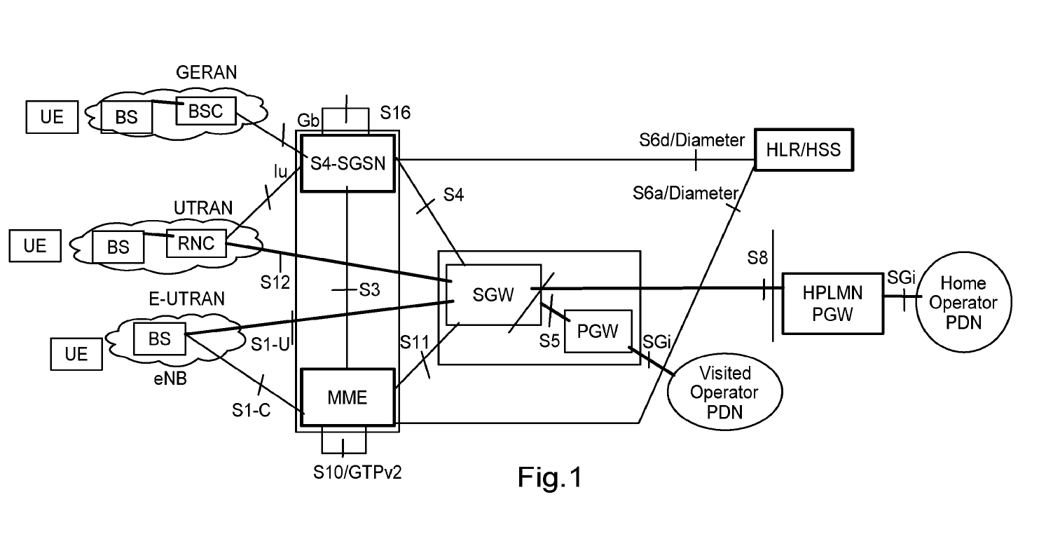

FIG. 2 illustrates a dual stack SMS-GW-MSC according to certain embodiments.

FIG. 3 illustrates a DIAMETER only SMS-GW-MSC according to certain embodiments.

FIG. 4 illustrates a method according to certain embodiments.

FIG. 5 illustrates another method according to certain embodiments.

FIG. 6 illustrates a system according to certain embodiments.

### DETAILED DESCRIPTION

As mentioned above, currently, second and third generation circuit switched (CS) infrastructure or support for an internet protocol (IP) multimedia subsystem (IMS) may be required to support voice and especially short message service (SMS) services in packet switched (PS), for example, circuit switched fallback (CSFB), single radio voice call continuity (SRVCC), and IMS based voice over IP (VoIP). For operators who do not support global system for mobile communications (GSM) CS infrastructure or who want to de-invest from CS in the future, IMS deployment can be used to provide these services. One approach is to use devices for SMS over IMS, the devices supporting an IMS/SIP client, which may impact SW deployment, complexity and maintenance. Moreover, the device may not need to support voice but may only need to support SMS. Examples may include data cards, dongles or machine-type-devices. Machine type devices with support for long term evolution (LTE) only, but without support for an IMS/SIP client, may be useful. Furthermore, when in-bound roamers, GSM and especially LTE devices with no IMS/SIP client come into these networks, they are unable to support SMS services. Also, when subscribers from these networks roam into other networks, they may not receive SMS services unless they have a circuit switched (CS) subscription.

As described above, one approach is to place SMS requirements on the MME. However, certain embodiments can configure a mobile switching center (MSC) to act as an SMS gateway, which can be seen as a “light-weight” MSC deployment.

Certain embodiments, therefore, can address interworking for deployments with no UTRAN CS or GERAN CS domain deployed. Thus, certain embodiments can rely on the functionalities of network elements and standards, for example a 3GPP compliant MSC server, which support SMS services, and use such a device as an SMS-gateway, for interworking in an example. This device can then be used for deployments without UTRAN CS (RNC) and GERAN CS (BSC). This device can support in-bound roamers where the home public land mobile network (HPLMN) supports only a legacy home subscriber server (HSS)/home location register (HLR), such as an HSS/HLR with existing mobile application protocol (MAP) based interfaces. In addition, based on the capabilities of the HSS/HLR the MME can either use the “SMS in MME” feature with enhanced S6a interface or register at the SMS-gateway MSC via the SGs interface.

The function of an SMS-gateway MSC, used for interworking, can include supporting SMS services in the LTE network via an SGs interface and interworking with SMSC via an E interface, which could be based on MAP or DIAMETER or both depending on deployments. This MSC acting as a SMS-gateway is not required to support the following functions that are supported by a traditional MSC: setup or release a user plane connection, CS voice services related functionality, mobility management functionalities (location update, IMSI-attach, CS paging over A/Iu-CS and the like), or the functions defined for G-MSC, V-MSC, A-MSC.

One way to configure an ordinary MSC server as an SMS-gateway MSC (or simply SMS-gateway) is by disabling the additional functionalities and only enabling the SMS services. SMS-gateways can be deployed at the network boundaries. Depending on the volume of SMS traffic, only a limited number of centrally deployed SMS-gateways may be sufficient.

In a particular embodiment, an MSC can act as an SMS-gateway supporting both MAP, for external interfaces, and DIAMETER, for internal interfaces. Particularly, the MSC can support a Diameter interface internally towards the HSS and externally MAP based interfaces like E and D.

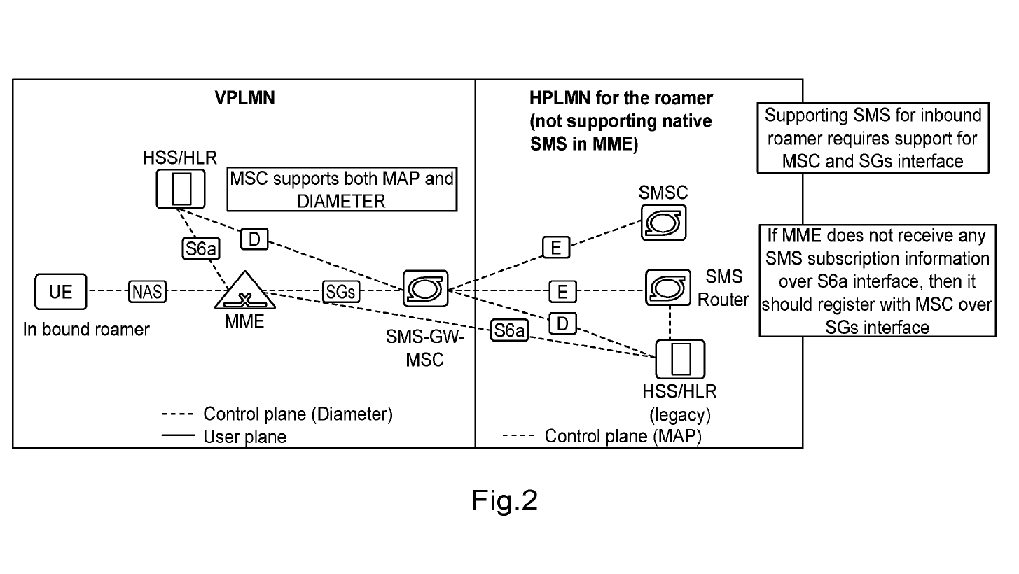

FIG. 2 illustrates a dual stack embodiment of an SMS-GW-MSC deployed for providing SMS services according to certain embodiments. As can be seen from FIG. 2, when an in-bound roamer UE is identified by an MME, the MME may communicate with the UE's legacy HSS/HLR. For providing SMS service, the MME may communicate via the SMS-GW-MSC and the SMS-GW-MSC can relay the communication to the HSS/HLR.

The D interface between the SMS-GW-MSC and the HSS/HLR within the VPLMN can be based on MAP or alternatively on DIAMETER, if the mobile operator decides to use only IP-based interfaces in the operator's own network. As a consequence, MAP-D can be converted to DIAMETER-D, either standardized or on a proprietary basis within the VPLMN. Standardized interfaces like MAP-D, MAP-E or DIAMETER-S6a can be used externally.

In an alternative embodiment, the MSC acting as a SMS-gateway may only support DIAMETER, but there can be an interworking function (IWF) deployed to perform protocol conversion at the edge of the network. The IWF can be collocated with the MSC.

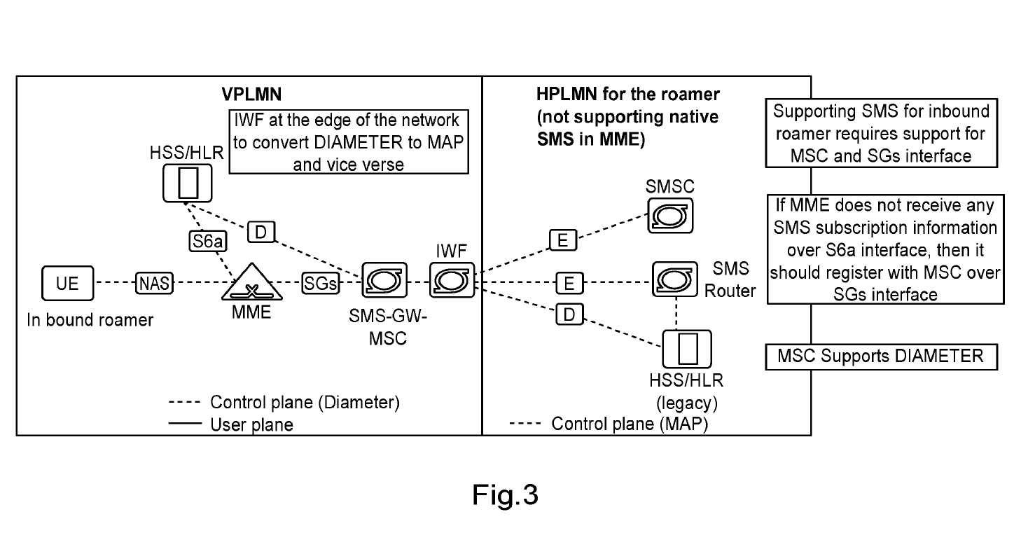

FIG. 3 illustrates a DIAMETER-only SMS-GW-MSC for SMS service. The communication in this case may be transmitted through the SMS-GW-MSC, which may then pass the communications on to an IWF to perform an appropriate protocol conversion, such as from DIAMETER to MAP.

The D interface between the SMS-GW-MSC and the HSS/HLR within the VPLMN can be based on MAP or alternatively on DIAMETER, if the mobile operator decides to use only IP-based interfaces in the operator's own network. As a consequence, MAP-D can be converted to DIAMETER-D, either standardized or on a proprietary basis within the VPLMN. Standardized interfaces like MAP-D, MAP-E or DIAMETER-S6a can be used externally.

Various embodiments can have an impact on user equipment. In networks where an MSC is deployed as a SMS-gateway, SMS services can be offered to the device either when the device is performing a combined attach or when the device is performing an EPS attach. This configuration, thus, also gives the ability for the network to offer SMS services when the UE is performing EPS attach, as long as the UE supports it.

Accordingly, UE(s) and inbound roamers when residing in the network where the SMS-gateway MSC is deployed can obtain SMS either upon EPS attach or upon combined attach. When they are roaming to other networks with CS domain deployments with legacy nodes, combined attach can be used to obtain SMS services.

Various embodiments can also have an impact on the MME. When the SMS-GW-MSC is deployed, the s6a interface can be enhanced to obtain SMS subscription information. If the s6a interface is enhanced, then SMS subscription retrieval and support for UE reachability notification functionality by the MSC using the D interface is unnecessary. When interworking with the legacy networks, if the HSS does not support retrieval of SMS subscription over s6a, then the MME can use the lack of SMS subscription information as an indication to indicate to the MSC, across SGs, that retrieval of subscription information from the HSS and support for UE reachability notification functionality is required.

If the SMS-GW-MSC is deployed mainly for interworking with legacy networks, for example only a very limited number of MSCs is deployed, and the MME still supports “SMS in MME” functionality, the following is how both the features, SMS over SGs and SMS in MME, can co-exist in the deployed network.

If the MME supports “native SMS in MME” and the MME does not receive any subscription information over the s6a interface, then the MME can register with the MSC over the SGs interface to provide SMS services. Alternatively, if the MME supports “native SMS in MME” and the MME receives subscription information over the S6a interface, then the MME can decide whether to invoke its own native SMS functionality or register with the MSC over the SGs interface to provide SMS services. The MSC may be pre-configured at the MME. The decision can depend, for example, on the congestion status in the SGs interface or on configuration/policies. Thus, for example, the decision can be based on the fact that the roaming partner supports enhanced S6a interface or not. If the home HSS/HLR indicates no support of enhanced S6a, the MME can decide to register at SMS-GW-MSC via SGs, otherwise it can invoke SMS in MME function, which can involve registering at HSS/HLR in the HPLMN and sending/receiving SMS to/from the SMSC. This can also allow for a migration from deployments with SMS-GW-MSC supporting SMS over SGs to deployments where no MSC or SMS-GW-MSC is needed anymore to support SMS in LTE, for example SMS in MME, when more and more networks support enhanced S6a interface in their HSS/HLR.

Deployment of SMS-gateway MSC for interworking may be beneficial in deployments where there is no support for UTRAN CS/GERAN CS and for devices that do not support IMS client in order to support inbound roamers. When SMS-gateway MSC is deployed for interworking with legacy networks, there is no issue due to idle mode signaling reduction (ISR) since the serving node registration need not be faked, thus addressing the problem mentioned above.

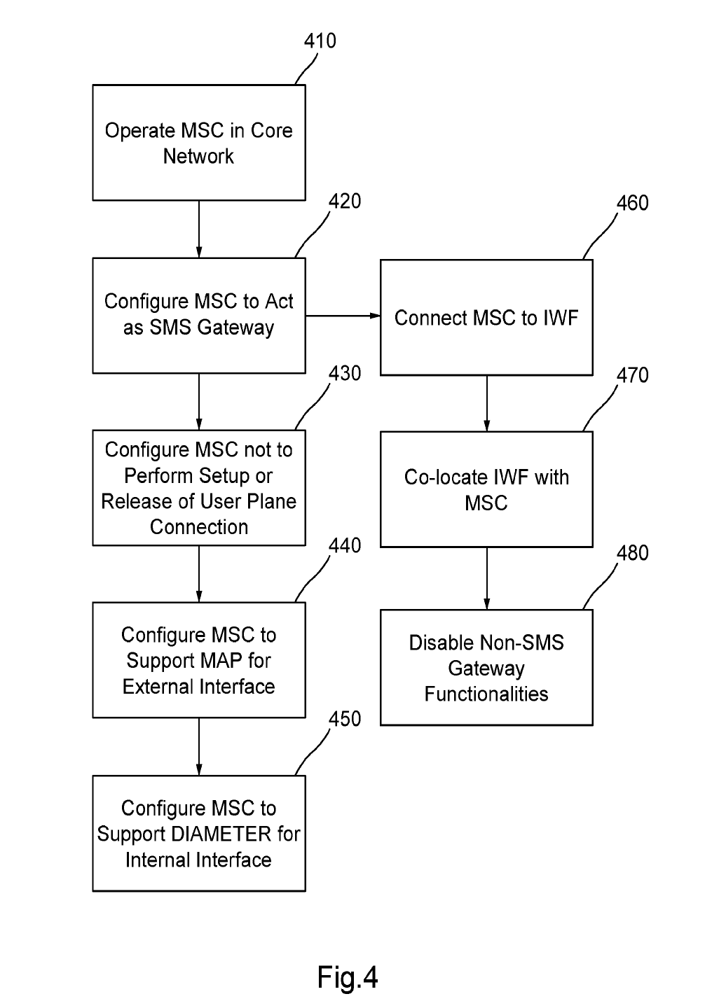

FIG. 4 illustrates a method according to certain embodiments. The method of FIG. 4 can be performed on or to form an SMS-GW MSC. As shown in FIG. 4, the method includes, at 410, operating a mobile switching center in a core network. The method also includes, at 420, configuring the mobile switching center to act as a short message service gateway.

The configuring the mobile switching center can include, at 430, configuring the mobile switching center not to perform setup or release of user plane connection. The configuring the mobile switching center can also include, at 440, configuring the mobile switching center to support a mobile application protocol for an external interface. The configuring the mobile switching center can also include, at 450, configuring the mobile switching center to support DIAMETER protocol for used at internal interfaces.

The configuring the mobile switching center can further include, at 460, connecting the mobile switching center to an interworking function that is configured to perform protocol conversion between the mobile application protocol and DIAMETER. More specifically, at 470, the method can include co-locating an interworking function with the mobile switching center, wherein the interworking function is configured to perform protocol conversion between mobile application protocol and DIAMETER for the mobile switching center. The configuring the mobile switching center can also include disabling functions of the mobile switching center that are not used in acting as a short message service gateway.

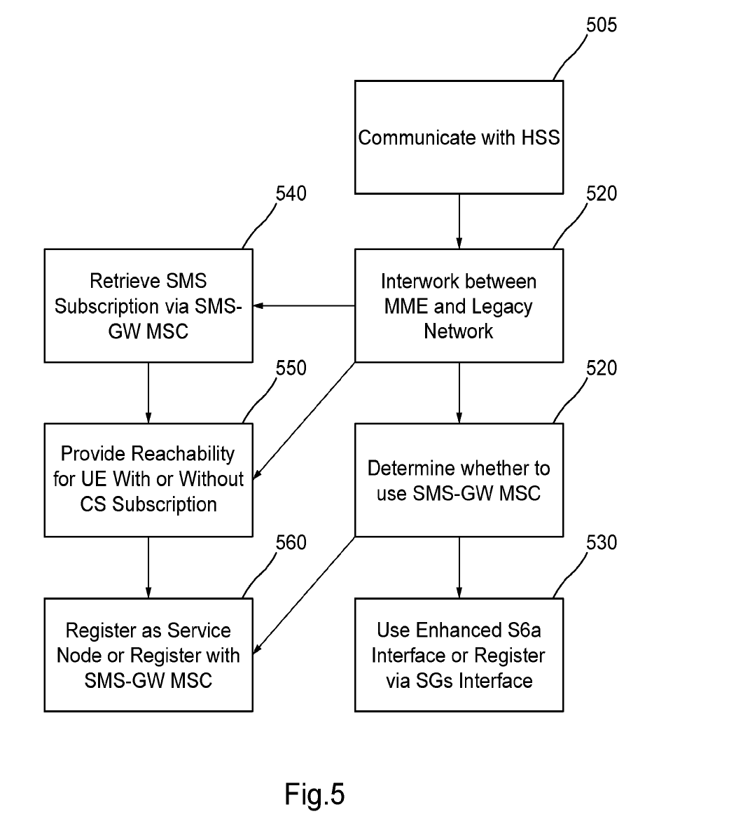

FIG. 5 illustrates a method according to certain embodiments. The method of FIG. 5 may be performed by, for example, an MME using an SMS-GW MSC. As shown in FIG. 5, the method can include, at 505, communicating, by a mobility management entity, regarding a user equipment with a home subscriber server of the user equipment. The method can include, at 510, interworking by a short message services gateway mobile switching center which is configured to support short message services only functionality and act as an interworking function for SMS between the evolved packet system, including the MME, and SMS Service layer. This may be, for example, a legacy system. The method can also include, at 520, determining whether to communicate with a short message service gateway mobile switching center regarding the user equipment based on communication with a home subscriber server. The method can more specifically include determining to communicate with the short message service gateway mobile switching center when the home subscriber server omits to provide short message service subscription information to the mobility management entity and determining not to communicate with the short message service gateway mobile switching center when the home subscriber server provides the short message service subscription information to the mobility management entity.

The method can further include, at 530, communicating with the short message service gateway mobile switching center over an enhanced S6a interface or registering at the short message service gateway mobile switching center via the SGs interface.

The method can additionally include, at 540, retrieving short message service subscription information regarding the user equipment via the short message service gateway mobile switching center. The method can also include, at 550, providing reachability on short message service for the user equipment. Moreover, the method can further include, at 560, registering as a serving node in the home subscriber server when it is determined that the mobility management entity can support service for short message service and registering with the short message service gateway mobile switching center when it is determined that the mobility management entity cannot support service for short message service. The short message service gateway mobile switching center can then register itself as a serving node for SMS routing in the HSS/HLR.

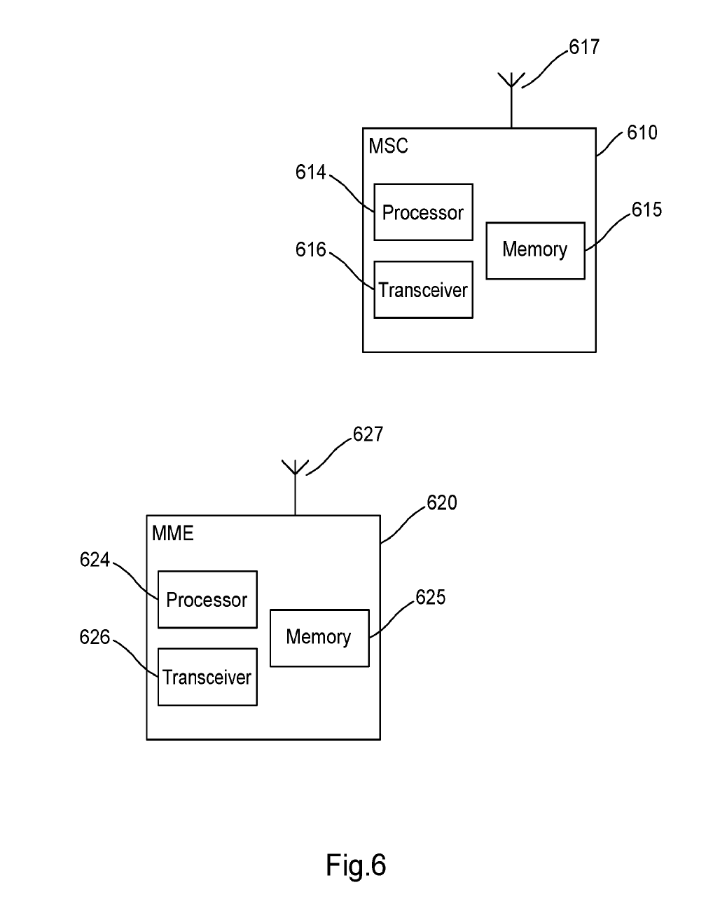

FIG. 6 illustrates a system according to certain embodiments. In an example embodiment, a system may include two devices, user equipment (MSC) 610 and MME 620. Each of the devices 610 and 620 may be equipped with at least one processor (respectively 614 and 624), at least one memory (respectively 615 and 625) (including computer program instructions or code), a transceiver (respectively 616 and 626), and an antenna (respectively 617 and 627). There is no requirement that each of these devices be so equipped. For example, the MME 620 and MSC 610 may be equipped for wired communication only. Here the antenna (respectively 617 and 627) can simply stand for any form of communication hardware, without requiring that an antenna be used.

The transceiver (respectively 616 and 626) can be a transmitter, a receiver, both a transmitter and a receiver, or a unit that is configured both for transmission and reception. The transceiver (respectively 616 and 626) can be coupled to corresponding one or more antenna(s) (respectively 617 and 627).

The at least one processor (respectively 614 and 624) can be variously embodied by any computational or data processing device, such as a central processing unit (CPU) or application specific integrated circuit (ASIC). The at least one processor (respectively 614 and 624) can be implemented as one or a plurality of controllers.

The at least one memory (respectively 615 and 625) can be any suitable storage device, such as a non-transitory computer-readable medium. For example, a hard disk drive (HDD) or random access memory (RAM) can be used in the at least one memory (respectively 615 and 625). The at least one memory (respectively 615 and 625) can be on a same chip as the corresponding at least one processor (respectively 614 and 624), or may be separate from the corresponding at least one processor (respectively 614 and 624).

The computer program instructions may be any suitable form of computer program code. For example, the computer program instructions may be a compiled or interpreted computer program.

The at least one memory (respectively 615 and 625) and computer program instructions can be configured to, with the at least one processor (respectively 614 and 624), cause a hardware apparatus (for example, user equipment 610 or MME 620) to perform a process, such as any of the processes described herein (see, for example, FIGS. 2-5).

Thus, in certain embodiments, a non-transitory computer-readable medium can be encoded with computer instructions that, when executed in hardware perform a process, such as one of the processes described herein. Alternatively, certain embodiments of the present invention may be performed entirely in hardware.

Although FIG. 6 illustrates a system including an MME and an MSC, certain embodiments may be applicable to other configurations and configurations involving additional elements as shown in FIGS. 2 and 3.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

Glossary of Abbreviations

SMS—Short Message Service

UE—User equipment

MSC—Mobile switching server

G-MSC—Gateway MSC—(note: this is different from the SMS-gateway MSC used for interworking—as in certain embodiments); G-MSC is the MSC that determines which visited MSC the subscriber who is being called is currently registered at. It may also interface with the public switched telephone network (PSTN).

V-MSC—Visited MSC

A-MSC—Anchor MSC

SMS-GW-MSC—SMS Gateway MSC (as mentioned in certain embodiments)

1. A method, comprising:
operating a mobile switching center in a core network; and
configuring the mobile switching center to act as a short message service gateway.

2. The method of claim 1, wherein the configuring the mobile switching center comprises configuring the mobile switching center not to perform setup or release of user plane connection.

3. The method of claim 1, wherein the configuring the mobile switching center comprises configuring the mobile switching center to support a mobile application protocol for an external interface.

4. The method of claim 1, wherein the configuring the mobile switching center comprises configuring the mobile switching center to support DIAMETER for internal interfaces.

5. The method of claim 1, wherein the configuring the mobile switching center comprises connecting the mobile switching center to an interworking function is configured to perform protocol conversion between mobile application protocol and DIAMETER.

6. (canceled)

7. The method of claim 1, wherein the configuring the mobile switching center comprises disabling functions of the mobile switching center that are not used in acting as a short message service gateway.

8. A method, comprising:
communicating, by a mobility management entity, regarding a user equipment with a home subscriber server of the user equipment; and
determining whether to communicate with a short message service gateway mobile switching center regarding the user equipment based on communication with the home subscriber server.

9. The method of claim 8, further comprising:
determining to communicate with the short message service gateway mobile switching center when the home subscriber server omits to provide short message service subscription information to the mobility management entity and determining not to communicate with the short message service gateway mobile switching center when the home subscriber server provides the short message service subscription information to the mobility management entity.

10. The method of claim 8, further comprising:
retrieving short message service subscription information regarding the user equipment via the short message service gateway mobile switching center.

11. (canceled)

12. The method of claim 8, further comprising:
communicating with the short message service gateway mobile switching center over an enhanced S6a interface or registering at the short message service gateway mobile switching center via the SGs interface.

13. The method of claim 8, further comprising:
registering as a serving node in the home subscriber server when it is determined that the mobility management entity can support service for short message service; and
registering with the short message service gateway mobile switching center when it is determined that the mobility management entity cannot support service for short message service.

14. An apparatus, comprising:
at least one memory including computer program code; and
at least one processor,
wherein the at least one memory and the computer program code are configured to, with the at least one processor, cause the apparatus at least to
operate a mobile switching center in a core network; and
configure the mobile switching center to act as a short message service gateway,
wherein the at least one memory and the computer program code are configured to, with the at least one processor, cause the apparatus at least not to perform setup or release of user plane connection using the mobile switching center.

15. (canceled)

16. (canceled)

17. The apparatus of claim 14, wherein the at least one memory and the computer program code are configured to, with the at least one processor, cause the apparatus at least to support DIAMETER for an internal interface using the mobile switching center.

18. (canceled)

19. (canceled)

20. The apparatus of claim 14, wherein the at least one memory and the computer program code are configured to, with the at least one processor, cause the apparatus at least to disable functions of the mobile switching center that are not used in acting as a short message service gateway.

21. An apparatus, comprising:
at least one memory including computer program code; and
at least one processor,
wherein the at least one memory and the computer program code are configured to, with the at least one processor, cause the apparatus at least to
communicate, by a mobility management entity, regarding a user equipment with a home subscriber server of the user equipment; and
determine whether to communicate with a short message service gateway mobile switching center regarding the user equipment based on communication with a home subscriber server.

22. The apparatus of claim 21, wherein the at least one memory and the computer program code are configured to, with the at least one processor, cause the apparatus at least to determine to communicate with the short message service gateway mobile switching center when the home subscriber server omits to provide short message service subscription information to the mobility management entity and to determine not to communicate with the short message service gateway mobile switching center when the home subscriber server provides the short message service subscription information to the mobility management entity.

23. The apparatus of claim 21, wherein the at least one memory and the computer program code are configured to, with the at least one processor, cause the apparatus at least to retrieve short message service subscription information regarding the user equipment via the short message service gateway mobile switching center.

24. (canceled)

25. The apparatus of claim 21, wherein the at least one memory and the computer program code are configured to, with the at least one processor, cause the apparatus at least to communicate with the short message service gateway mobile switching center over an enhanced S6a interface or to register at the short message service gateway mobile switching center via the SGs interface.

26. The apparatus of claim 21, wherein the at least one memory and the computer program code are configured to, with the at least one processor, cause the apparatus at least to register as a serving node in the home subscriber server when it is determined that the mobility management entity can support service for short message service and register with the short message service gateway mobile switching center when it is determined that the mobility management entity cannot support service for short message service.

27. A non-transitory computer-readable medium encoded with instructions that, when executed in hardware, perform a process, the process comprising the method according to claim 1.

28.-40. (canceled)
